(19) United States
(12) Patent Application Publication
(10) Pub. No.: US 2026/0361175 A1
(43) Pub. Date: Nov. 12, 2026

(54) TERMINAL BLOCK MODULE AND SPEED SENSOR-INTEGRATED TERMINAL BLOCK MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tomoki ABE, Mie (JP); Daisuke HASHIMOTO, Mie (JP); Kentaro TACHI, Mie (JP); Haruko YASUMURA, Mie (JP)

(21) Appl. No.: 19/141,318

(22) PCT Filed: Nov. 2, 2023
(86) PCT No.: PCT/JP2023/039672

§ 371 Date: Jun. 20, 2025

(30) Foreign Application Priority Data
Dec. 22, 2022 (JP) 2022-205337

(51) Int. Cl. H02K 5/22; H02K 3/50; H02K 11/215

(52) U.S. Cl. CPC H02K 5/225; H02K 3/50; H02K 11/215; H02K 2203/09

(57) ABSTRACT

The purpose of the present invention is to make it possible for wiring connected to a speed sensor incorporated in a rotary electric machine to be easily connected to wiring outside the rotary electric machine. This terminal block module is fixed to a device case of a rotary electric machine comprising a speed sensor. The terminal module comprises: a connection member for electrically connecting an inner busbar terminal on the inside of the device case and an outer busbar terminal on the outside of the device case; a terminal block body fixed to the device case in a state of holding the connection member; an internal connector for a speed sensor, said connector having an inner terminal for a speed sensor and being supported by the terminal block body so as to be positioned inside the device case; and speed sensor wiring that is at least partially held in the terminal block body and connects the inner terminal for a speed sensor to a circuit from outside the device case.

### TECHNICAL FIELD

The present disclosure relates to a terminal block module and a speed sensor-integrated terminal block module.

### BACKGROUND

Patent Document 1 discloses an electrical machine provided with a position sensor arranged adjacent to a stator in an axial direction for detecting the position of a rotor.

### PRIOR ART DOCUMENT

### Patent Document

Patent Document 1: International Publication No. WO 2020/259908 A1

### SUMMARY OF THE INVENTION

### Problems to be Solved

It is desired to enable a wiring extending from a speed sensor to be easily connected to a wiring outside a rotating electric machine.

Accordingly, the present disclosure aims to enable a wiring connected to a speed sensor to be incorporated into a rotating electric machine to be easily connected to a wiring outside the rotating electric machine.

### Means to Solve the Problem

The present disclosure is directed to a terminal block module to be fixed to a device case of a rotating electric machine provided with a speed sensor, the terminal block module being provided with a connecting member for electrically connecting an inner busbar terminal in the device case and an outer busbar terminal outside the device case, a terminal block body to be fixed to the device case while holding the connecting member, an internal connector for speed sensor including an inner terminal for speed sensor, the internal connector for speed sensor being supported by the terminal block body to be located in the device case, and a speed sensor wiring at least partially held in the terminal block body, the speed sensor wiring connecting the inner terminal for speed sensor to a circuit from outside of the device case.

### Effect of the Invention

According to the present disclosure, a wiring connected to a speed sensor to be incorporated into a rotating electric machine can be easily connected to a wiring outside the rotating electric machine.

### BRIEF DESCRIPTION OF THE DRAWINGS

FIG. 1 is a perspective view showing a mechanically and electrically integrated unit according to an embodiment.

FIG. 2 is an exploded perspective view showing the mechanically and electrically integrated unit.

FIG. 3 is an exploded perspective view showing the mechanically and electrically integrated unit.

FIG. 4 is a perspective view showing a coil end module.

FIG. 5 is a perspective view showing a part assembled with a temperature sensor and a temperature sensor side connector, out of the coil end module.

FIG. 6 is a perspective view showing a terminal block module.

FIG. 7 is a perspective view showing the terminal block module.

FIG. 8 is a perspective view showing a connecting member.

FIG. 9 is an exploded perspective view showing the connecting member.

FIG. 10 is a diagram showing a state during the connection of a terminal to the connecting member.

FIG. 11 is a diagram showing a connected state of the terminal to the connecting member.

FIG. 12 is a perspective view showing a terminal assembly.

FIG. 13 is a diagram showing a state during the manufacturing of the mechanically and electrically integrated unit.

FIG. 14 is a diagram showing a state during the manufacturing of the mechanically and electrically integrated unit.

### DETAILED DESCRIPTION TO EXECUTE THE INVENTION

### Description of Embodiments of Present Disclosure

First, embodiments of the present disclosure are listed and described.

The terminal block module of the present disclosure is as follows.
(1) The terminal block module of the present disclosure is to be fixed to a device case of a rotating electric machine provided with a speed sensor, and provided with a connecting member for electrically connecting an inner busbar terminal in the device case and an outer busbar terminal outside the device case, a terminal block body to be fixed to the device case while holding the connecting member, an internal connector for speed sensor including an inner terminal for speed sensor, the internal connector for speed sensor being supported by the terminal block body to be located in the device case, and a speed sensor wiring at least partially held in the terminal block body, the speed sensor wiring connecting the inner terminal for speed sensor to a circuit from outside of the device case.

According to the present disclosure, if the terminal block body holding the connecting member is fixed to the device case, the internal connector for speed sensor is arranged in the device case. If the speed sensor is connected to the internal connector for speed sensor, the speed sensor is connected to a wiring outside the rotating electric machine via the speed sensor wiring. Thus, the wiring connected to the speed sensor to be incorporated into the rotating electric machine can be easily connected to the wiring outside the rotating electric machine.
(2) In the terminal block module of (1), the terminal block body may be a resin component molded with at least a part of the speed sensor wiring as an insert part.

In this way, the passage of a liquid along the speed sensor wiring is suppressed.
(3) In the terminal block module of (1) or (2), the terminal block body may support the internal connector for speed sensor at a position facing a connector of the speed sensor to be incorporated into the device case.

In this way, the connector of the speed sensor can be easily connected to the internal connector for speed sensor in incorporating the speed sensor into the device case.
(4) In the terminal block module of any one of (1) to (3), a connection direction of a connector of the speed sensor to the internal connector for speed sensor may be set along a rotation axis direction of the rotating electric machine.

Various components of the rotating electric machine are often assembled along the rotation axis direction of the rotating electric machine. Thus, if the connection direction of the speed sensor to the internal connector for speed sensor is along the rotation axis direction, a connecting operation of those is easily performed.
(5) The terminal block module of any one of (1) to (4) may be further provided an external connector including an outer terminal for speed sensor connected to the speed sensor wiring, the external connector being supported by the terminal block body to be connectable to a connector from the outside of the device case.

In this case, a device outside the rotating electric machine can be easily connected to the speed sensor wiring by connecting the connector from the outside of the device case to the external connector.
(6) In the terminal block module of (5), the internal connector for speed sensor may include an internal connector housing, the external connector may include an external connector housing, the inner terminal for speed sensor, the outer terminal for speed sensor and the speed sensor wiring may be integrally formed as a metal wiring member, the terminal block body, the internal connector housing and the external connector housing may be components integrally molded of resin, and the inner terminal for speed sensor may be located in the internal connector housing, the outer terminal for speed sensor may be located in the external connector housing and the speed sensor wiring may be arranged as an insert part in the terminal block body.

In this way, one and the other ends of the metal wiring member can be utilized as terminals of the connectors and, by integrally molding the terminal block body, the internal connector housing and the external connector housing of resin, the terminal block module including the both connectors can be easily manufactured. Since an intermediate part of the sensor wiring is arranged in the terminal block body, a water-stopping property is also excellent.
(7) In the terminal block module of (5) or (6), a connection direction of an outer connector to the external connector may be set along a direction from an outer peripheral side toward an inner peripheral side of the device case.

In this case, a connection direction of the outer busbar terminal to the connecting member and the connection direction of the outer connector to the external connector are easily aligned, and a connecting operation of those is easily performed.
(8) In the terminal block module of any one of (1) to (7), the terminal block body may include an inner opening for receiving the inner busbar terminal along the rotation axis direction of the rotating electric machine and an outer opening for receiving the outer busbar terminal along a direction from an outer peripheral side toward an inner peripheral side of the device case, and the connecting member may press the inner busbar terminal received through the inner opening against the outer busbar terminal received through the outer opening.

In this case, if the inner busbar terminal is inserted into the inner opening along the rotation axis direction and the outer busbar terminal is inserted into the outer opening from the outer peripheral side toward the inner peripheral side of the device case, the inner busbar terminal and the outer busbar terminal are easily connected.

Further, a speed sensor-integrated terminal block module of the present disclosure is as follows.
(9) The speed sensor-integrated terminal block module of the present disclosure is provided with the terminal block module of (3) and the speed sensor connected to the internal connector for speed sensor.

In this way, the speed sensor and the terminal block module are easily integrated in a state easily incorporated into the device case.

### Details of Embodiment of Present Disclosure

Specific examples of a terminal block module and a speed sensor-integrated terminal block module of the present disclosure are described below with reference to the drawings. Note that the present disclosure is not limited to these illustrations, but is represented by claims and intended to include all changes in the scope of claims and in the meaning and scope of equivalents.

### EMBODIMENT

Hereinafter, a terminal block module and a speed sensor-integrated terminal block module according to an embodiment are described. In this embodiment, an example in which the terminal block module and the speed sensor-integrated terminal block module are incorporated in a mechanically and electrically integrated unit is described.

### Overall Configuration

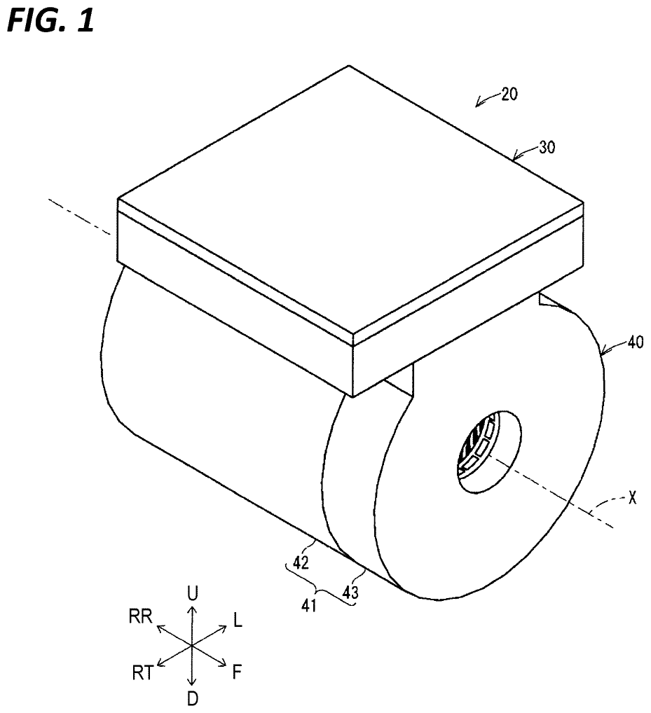

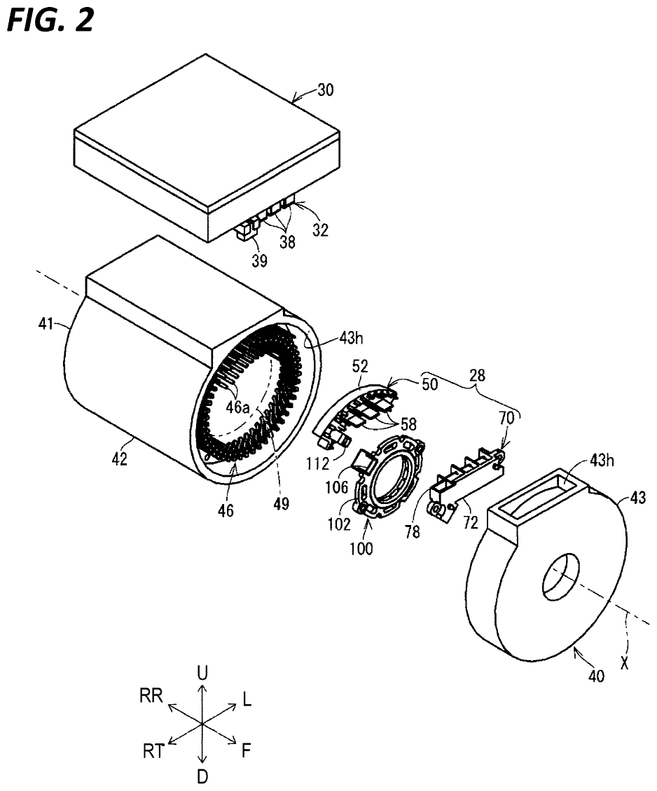

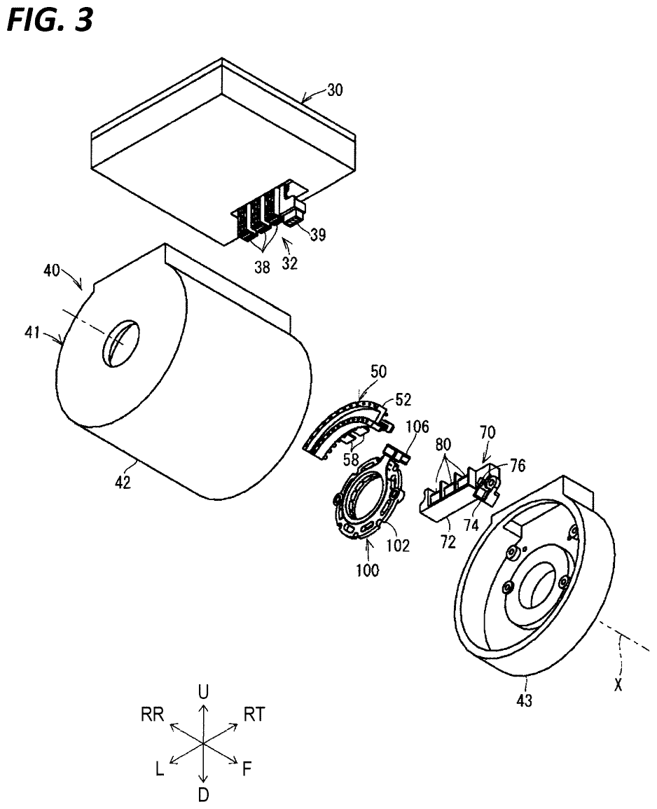

For the convenience of description, the overall configuration of the mechanically and electrically integrated unit is described. FIG. 1 is a perspective view showing a mechanically and electrically integrated unit 20. FIGS. 2 and 3 are exploded perspective view showing the mechanically and electrically integrated unit 20.

The mechanically and electrically integrated unit 20 is a unit formed by integrating a rotating electric machine 40 and a control device 30 for controlling the rotating electric machine 40.

The rotating electric machine 40 is provided with a device case 41, an armature 46 and a field magnet 49. The rotating electric machine 40 may be an electric motor or may be a generator.

The device case 41 includes a case body 42 in the form of a bottomed tube and a lid portion 43. The armature 46 serving as a stator is accommodated in the case body 42. The field magnet 49 is arranged as a rotor in the armature 46. The field magnet 49 is rotated by a magnetic field generated by the armature 46 or the armature 46 is caused to generate an electromotive force by the rotation of the field magnet 49.

The armature 46 includes coil wires 46a. The coil wires 46a are linear electrically conductive members constituted by copper wires or the like. The coil wires 46a may be wound on an armature core.

The control device 30 is, for example, an inverter device for driving and controlling the rotating electric machine 40. The control device 30 is assumed to be integrated with the device case 41 of the rotating electric machine 40 by bolt fixing or the like.

Outer busbar terminals 38 extend from the control device 30. The coil wires 46a are connected to the outer busbar terminals 38 via a coil end module 50 and a terminal block module 70.

The coil end module 50 is located on an opening side of the case body 42, out of the armature 46. The coil end module 50 includes coil end lead terminals 58 to be connected to the coil wires 46a in the device case 41. The coil end lead terminals 58 extend toward the opening side of the case body 42 from the armature 46. The coil end lead terminals 58 extend toward the terminal block module 70. The coil end lead terminals 58 are examples of inner busbar terminals in the device case 41.

The coil end module 50 may be configured to connect ends of a plurality of the coil wires 46a of the armature 46.

The terminal block module 70 is located adjacent to the coil end module 50 in a direction of a rotation axis X of the rotating electric machine 40. The terminal block module 70 is mounted inside the lid portion 43. An opening 43h is formed in a part of the lid portion 43 on the side of the control device 30 for the terminal block module 70. If the control device 30 is attached to the rotating electric machine 40, the outer busbar terminals 38 extend toward the terminal block module 70 through the opening 43h.

The coil end lead terminals 58 and the outer busbar terminals 38 are electrically connected by the terminal block module 70.

In this embodiment, the rotating electric machine 40 is assumed to be usable as a three-phase alternating current motor. Thus, the rotating electric machine 40 includes three coil end lead terminals 58, and the control device 30 includes three outer busbar terminals 38. Each of the three coil end lead terminals 58 is electrically connected to each of the three outer busbar terminals 38 by the terminal block module 70.

In the following description, the side of the lid portion 43 may be referred to as a front side and an opposite side thereof may be referred to as a rear side in a direction along the rotation axis X of the rotating electric machine 40. Further, the side of the rotating electric machine 40 may be referred to as a lower side and the side of the control device 30 may be referred to as a lower side in a direction orthogonal to the rotation axis X. Further, a lateral direction may be referred to on the basis of the upper and lower sides and the front and rear sides.

Further, the rotating electric machine 40 is provided with a speed sensor 100. The speed sensor 100 is, for example, a sensor for detecting a rotation speed of the field magnet 49 by detecting a rotation angle of the field magnet 49 serving as the rotor. The speed sensor 100 may be a sensor called a resolver.

Further, the rotating electric machine 40 is provided with a temperature sensor 110. The temperature sensor 110 is a sensor for detecting a temperature in the rotating electric machine 40, e.g. a temperature of the coil wire 46a.

A detection signal of the speed sensor 100 and a detection signal of the temperature sensor 110 are given to the control device 30. In this way, the control device 30 can control the rotating electric machine 40 based on the detection signal of the speed sensor 100 and the detection signal of the temperature sensor 110.

The terminal block module 70 includes an internal connector 74 for speed sensor to be connected to the speed sensor 100 in the device case 41. Further, the terminal block module 70 includes a wiring for transmitting the detection signal of the speed sensor 100 to outside. Thus, the detection signal of the speed sensor 100 in the device case 41 can be easily output to outside via the internal connector 74 for speed sensor and this wiring.

Further, the terminal block module 70 includes an internal connector 76 for temperature sensor to be connected to the temperature sensor 110 in the device case 41. Further, the terminal block module 70 includes a wiring for transmitting the detection signal of the temperature sensor 110 to outside. Thus, the detection signal of the temperature sensor 110 in the device case 41 can be easily output to outside via the internal connector 76 for temperature sensor and this wiring. The internal connector 76 for temperature sensor and the wiring therefor may be configured separately from the terminal block module or may be omitted.

The configuration of each component is described below.

### Coil End Module

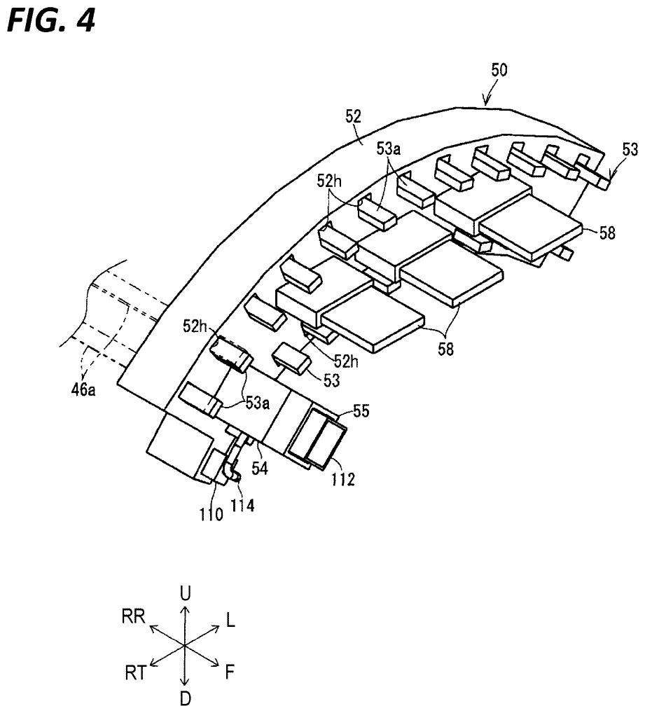

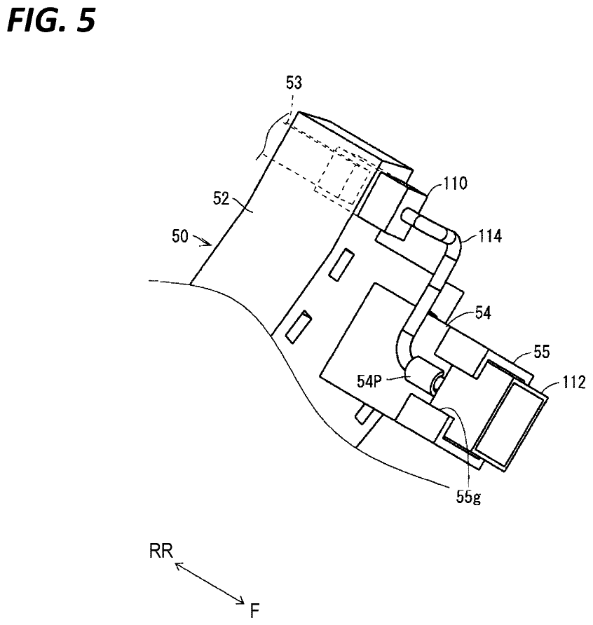

FIG. 4 is a perspective view showing the coil end module 50. Parts of the coil wires 46a extending from the armature 46 are shown in FIG. 4. FIG. 5 is a perspective view showing a part of the coil end module 50 assembled with the temperature sensor 110 and a temperature sensor side connector 112.

As shown in FIGS. 2 to 5, the coil end module 50 includes the coil end lead terminals 58 and a coil end holding portion 52.

The coil end lead terminals 58 are connected to the coil wires 46a. The coil end holding portion 52 supports the coil end lead terminals 58 in a cantilever manner along the direction of the rotation axis X of the rotating electric machine 40.

More specifically, the coil end holding portion 52 is formed by an insulating member made of resin or the like. The coil end holding portion 52 is formed with insertion holes 52h, into which the plurality of coil wires 46a extending from the armature 46 are insertable. In FIG. 4, some of end parts of the plurality of coil wires 46a are shown.

The coil end holding portion 52 has an arcuate shape to be arrangeable in a circumferential part of an end surface of the armature 46 on the side of the lid portion 43. The coil end holding portion 52 holds a relay busbar 53. The relay busbar 53 is an electrically conductive member formed from a metal plate of copper or the like. The relay busbar 53 includes connection ends 53a arrangeable adjacent to the coil wires 46a inserted into the insertion holes 52h. The end parts of the coil wires 46a inserted into the insertion holes 52h are electrically connected to the connection ends 53a. For example, the coil wires 46a may be joined to the connection ends 53a. These may be joined by TIG welding, laser welding, resistance welding, ultrasonic welding, soldering or crimping.

The relay busbar 53 includes intermediate connecting portions for connecting a plurality of the connection ends 53a in a predetermined combination. In this way, the plurality of coil wires 46a connected to the connection ends 53a are electrically connected in the predetermined combination.

The coil end lead terminals 58 extend from the surface of the coil end holding portion 52 on the side of the lid portion 43. As described above, the three coil end lead terminals 58 extend from the coil end holding portion 52. The three coil end lead terminals 58 are located at intervals along an arc having a center of curvature on the rotation axis X. Each coil end lead terminal 58 is along the rotation axis X.

The coil end lead terminal 58 may be connected to the connection end 53a connected to any one of the coil wires 46a via the intermediate connecting portion. For example, the coil end lead terminal 58 may be a metal plate part integrally formed with the relay busbar 53. The coil end lead terminal 58 may be directly connected to the coil wire 46a.

The coil end lead terminal 58 is in the form of an elongated plate. One principal surface of the coil end lead terminal 58 is facing inwardly of the device case 41, and the other principal surface is facing outwardly of the device case 41. Thus, the coil end lead terminal 58 can be deformed to displace a tip part in directions toward inner and outer peripheries of the device case 41 with a base end part supported in a cantilever manner by the coil end holding portion 52 as a center.

Further, the coil end module 50 includes the temperature sensor 110 and the temperature sensor side connector 112.

The temperature sensor 110 is thermally coupled to the coil wire 46a. That the temperature sensor 110 is thermally coupled to the coil wire 46a means a state where a temperature change of the coil wire 46a can be detected by the temperature sensor 110. For example, the temperature sensor 110 may be in contact with the coil wire 46a directly or via a heat conductive member made of copper or the like. That is, the heat conductive member, whose temperature is measured by the temperature sensor 110, may be the coil wire 46a itself, may be the relay busbar 53 joined to the coil wire 46a, may be a heat conductive relay member connected to the coil wire 46a separately from the relay busbar 53 or may be a part branched from a halfway position of the coil wire 46a and pulled out.

The temperature sensor 110 may be, for example, a sensor obtained by covering a thermistor element with resin. A contact state of the temperature sensor 110 and the coil wire 46a or the heat conductive member may be held, for example, by the following configurations.

The temperature sensor 110 may be held at a fixed position by the coil end holding portion 52 and the heat conductive member may be inserted into the coil end holding portion 52 and held in contact with the temperature sensor 110. Further, the temperature sensor 110 and the heat conductive member may be held in the coil end holding portion 52 while being held in contact with each other, and the heat conductive member may be joined to the coil wire 46a by welding or the like. The heat conductive member may include a crimping piece, and this crimping piece may be crimped to the temperature sensor 110.

A wire 114 serving as an example of a wiring extends from the temperature sensor 110. The temperature sensor side connector 112 is connected to an end part of the wire 114. The temperature sensor side connector 112 is connected to the temperature sensor 110 via the wire 114.

The coil end holding portion 52 holds the temperature sensor side connector 112 at a position connectable to the internal connector 76 for temperature sensor on the side of the terminal block module 70.

Here, a connector holding portion 54 projects at a position near one end of the coil end holding portion 52. More specifically, the connector holding portion 54 projects from a position avoiding the coil wire 46a and the connection end 53a on a surface facing the terminal block module 70, out of the coil end holding portion 52. The connector holding portion 54 projects along the rotation axis X. An inner connector receiving portion 55 is formed on a tip part of the connector holding portion 54. The inner connector receiving portion 55 is in the form of a box open toward the terminal block module 70. The inner peripheral surface of the inner connector receiving portion 55 is larger than the outer peripheral surface of the temperature sensor side connector 112, and the temperature sensor side connector 112 can move in a direction orthogonal to the rotation axis X in the inner connector receiving portion 55. A wire insertion groove 55g is formed from the peripheral wall to the bottom surface of the inner connector receiving portion 55. The wire 114 extending from the temperature sensor side connector 112 is drawn toward the temperature sensor 110 through the inside of the wire insertion groove 55g.

The temperature sensor side connector 112 is held by accommodating a base end part of the temperature sensor side connector 112 into the inner connector receiving portion 55. In this state, the temperature sensor side connector 112 can move in the direction orthogonal to the rotation axis X within a range restricted by the inner surface of the inner connector receiving portion 55. Further, a movement toward the armature 46 along the direction of the rotation axis X is restricted by the bottom surface of the inner connector receiving portion 55.

The temperature sensor side connector 112 is facing toward the terminal block module 70, and the temperature sensor side connector 112 and the internal connector 76 for temperature sensor on the side of the terminal block module 70 can be connected by moving the coil end module 50 and the terminal block module 70 closer along the rotation axis X. At this time, the temperature sensor side connector 112 can move in the direction orthogonal to the rotation axis X according to position errors of the both connectors 112, 76.

A wire supporting portion 54P capable of supporting the wire 114 may be provided outside the inner connector receiving portion 55 on the connector holding portion 54. By supporting the wire 114 by the wire supporting portion 54P, the temperature sensor side connector 112 can be made difficult to come out from the inner connector receiving portion 55.

### Terminal Block Module

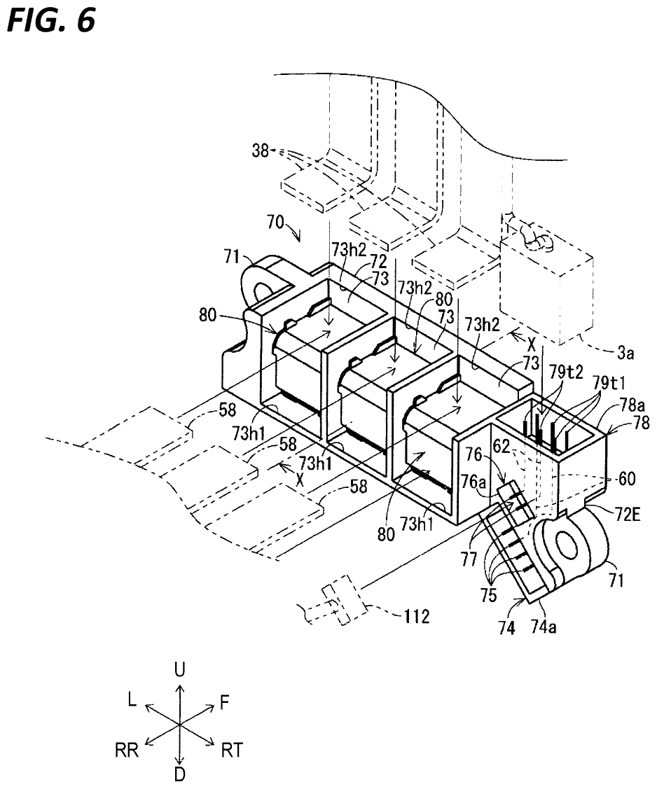

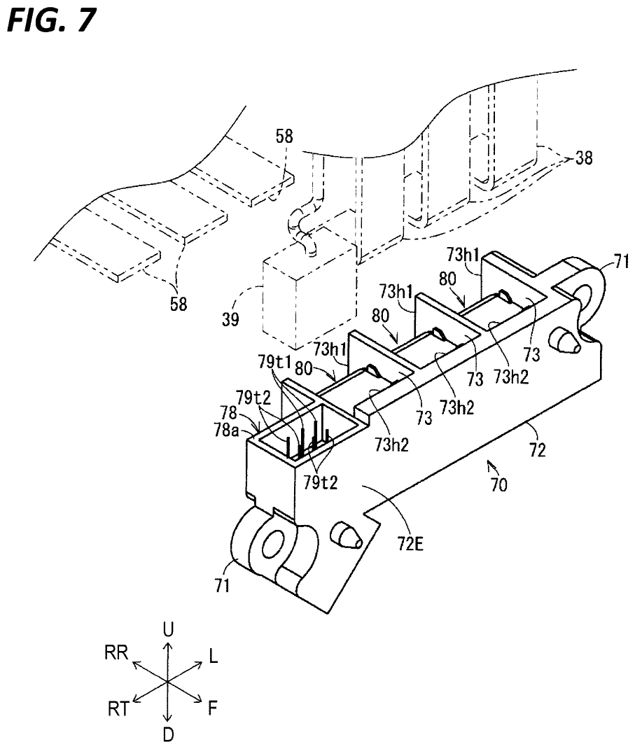

FIGS. 6 and 7 are perspective views showing the terminal block module 70. In FIGS. 6 and 7, the coil end lead terminals 58 and the outer busbar terminals 38 are shown by two-dot chain lines. As shown in FIGS. 2, 3, 6 and 7, the terminal block module 70 is a member to be fixed in the device case 41. The terminal block module 70 includes connecting members 80 and a terminal block body 72.

The connecting member 80 is a member for electrically connecting the coil end lead terminal 58 serving as an inner busbar terminal and the outer busbar terminal 38 outside the device case 41. The connecting member 80 may need not have a main function for electrically connecting the coil end lead terminal 58 and the outer busbar terminal 38 and may have an auxiliary function. That is, for example, the connecting member 80 needs not become an electrically conductive path between the coil end lead terminal 58 and the outer busbar terminal 38.

In this embodiment, the connecting member 80 biases the coil end lead terminal 58 to the outer busbar terminal 38, thereby functioning to more reliably hold the both terminals 58, 38 in an electrically connected state.

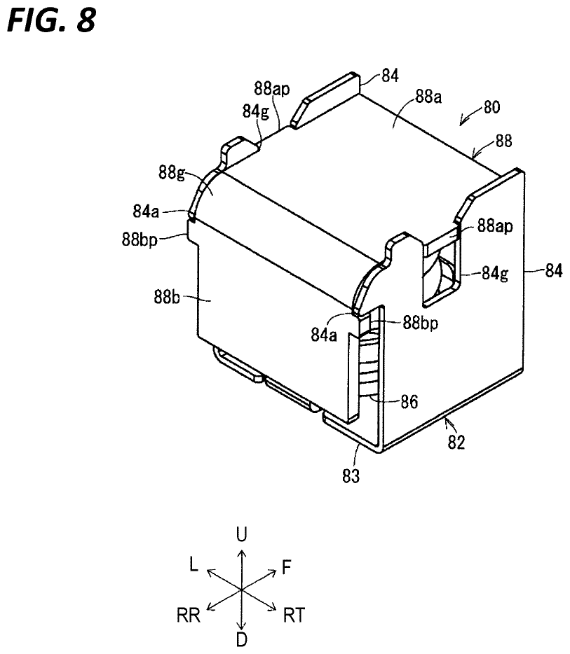

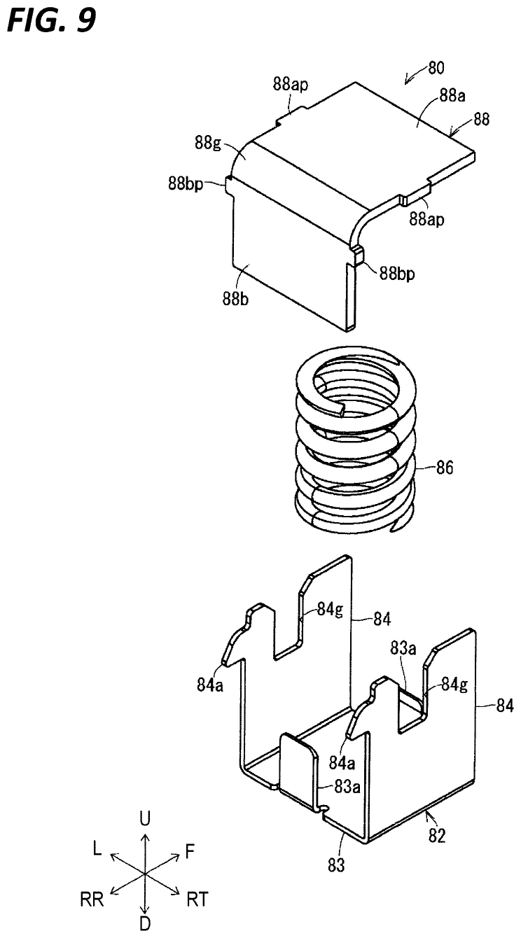

FIG. 8 is a perspective view showing the connecting member 80. FIG. 9 is an exploded perspective view showing the connecting member 80. As shown in FIGS. 6 to 9, the connecting member 80 is provided with a supporting member 82, a biasing member 86 and a pressing piece 88.

The supporting member 82 includes a bottom portion 83 and supports the biasing member 86 on the bottom portion 83. For example, the supporting member 82 is formed, such as by press-working a metal plate. The supporting member 82 includes the bottom portion 83 and a pair of side plates 84. The bottom portion 83 is in the form of a rectangular plate. The pair of side plates 84 extend from both side parts of the bottom portion 83 toward one principal surface side of the bottom portion 83. Positioning pieces 83a project on both front and rear edges of the bottom portion 83. The biasing member 86 on the bottom portion 83 is positioned on the bottom portion 83 while being located between the pair of side plates 84 and the front and rear positioning pieces 83a.

A guide groove 84g extending along an extension direction of the side plate 84 is formed in a tip part of the side plate 84. A retaining piece 84a projects from the upper end of the rear side edge of the bottom portion 83. Moving directions and a movement range of the pressing piece 88 are restricted by the guide grooves 84g and the retaining pieces 84a.

The biasing member 86 is a resilient member such as a coil spring. The biasing member 86 may be a leaf spring, a disc spring, a rubber or the like. The biasing member 86 is supported on the bottom portion 83. An upper end part of the biasing member 86 is located more away from the bottom portion 83 than the retaining pieces 84a.

The pressing piece 88 is supported movably in directions toward and away from the bottom portion 83 by the supporting member 82. The pressing piece 88 is, for example, formed, such as by press-working a metal plate.

In this embodiment, the pressing piece 88 includes a pressing plate portion 88a, a guide portion 88g and a hanging plate portion 88b.

The pressing plate portion 88a is in the form of a flat plate and, here, a rectangular plate. The pressing plate portion 88a is located on a side opposite to the bottom portion 83 with respect to the biasing member 86. That is, the pressing plate portion 88a is located on the biasing member 86. The pressing plate portion 88a is orthogonal to a biasing direction of the biasing member 86, i.e. parallel to the bottom portion 83. The biasing member 86 is interposed in a compressed state between the pressing plate portion 88a and the bottom portion 83. When the pressing plate portion 88a moves toward or away from the bottom portion 83 as the biasing member 86 contracts or expands, the pressing plate portion 88a contacts the inner surfaces of the pair of side plates 84, whereby the pressing plate portion 88a is positioned in the lateral direction.

Further, protrusions 88ap project on both sides of the pressing plate portion 88a. The protrusions 88ap move along the guide grooves 84g. When the pressing plate portion 88a moves, the protrusion 88ap contacts both side edges of the guide groove 84g on each of left and right sides of the pressing plate portion 88a, whereby the pressing plate portion 88a is positioned in a front-rear direction.

The guide portion 88g extends from a rear side of the peripheral edge of the pressing plate portion 88a, i.e. an edge on the side of the coil end module 50. The guide portion 88g extends to gradually approach the bottom portion 83 in a direction away from the pressing plate portion 88a. In this embodiment, the guide portion 88g extends rearward and downward while forming a partial tube shape from the rear edge of the pressing plate portion 88a.

The hanging plate portion 88b extends toward the bottom portion 83 along the biasing direction of the biasing member 86 from the tip edge of the guide portion 88g. The hanging plate portion 88b covers the biasing member 86 from the side of the coil end module 50.

Protrusions 88bp project on upper parts of both side edges of the hanging plate portion 88b. The protrusions 88bp vertically move along the rear edges of the side plates 84 and contact the retaining pieces 84 from the side of the bottom portion 83. The protrusions 88bp contact the retaining pieces 84a, thereby restricting a movement of the pressing piece 88 in the direction away from the bottom portion 83.

The protrusions 88ap, 88bp of the pressing piece 88 are restricted from moving by the guide grooves 84g and the retaining pieces 84a, whereby the supporting member 82 supports the pressing piece 88 reciprocally movably between a standby position and a proximate position closer to the bottom portion 83 than the standby position. In this embodiment, the standby position is a position where the protrusions 88bp are in contact with the retaining pieces 84a from the side of the bottom portion 83. The standby position is a position where the protrusions 88ap are in contact with the edges of the guide grooves 84g on the side of the bottom portion 83.

The terminal block body 72 is made of resin or the like, and fixed to the lid portion 43 of the device case 41 while holding the connecting members 80.

More specifically, the terminal block body 72 is in the form of an elongated plate. The terminal block body 72 is formed with accommodation recesses 73 for accommodating the connecting members 80. In this embodiment, since the terminal block body 72 holds three connecting members 80, three accommodation recesses 73 are formed side by side along an extension direction of the terminal block body 72. The terminal block body 72 is integrally formed with screwing portions 71 serving as attaching portions. The terminal block body 72 is screwed and fixed to the lid portion 43 via the screwing portions 71.

The terminal block body 72 includes inner openings 73h1 and outer openings 73h2. Each accommodation recess 73 is open at the inner opening 73h1 and the outer opening 73h2.

The inner opening 73h1 is an opening for receiving the coil end lead terminal 58 serving as the inner busbar terminal along the rotation axis X. That is, the inner opening 73h1 is open on a forward extension of the coil end lead terminal 58.

The outer opening 73h2 is an opening for receiving the outer busbar terminal 38 along a direction from an outer peripheral side toward an inner peripheral side of the device case 41. That is, the outer opening 73h2 is open on an extension of the outer busbar terminal 38 extending from the control device 30 to be attached to the rotating electric machine 40.

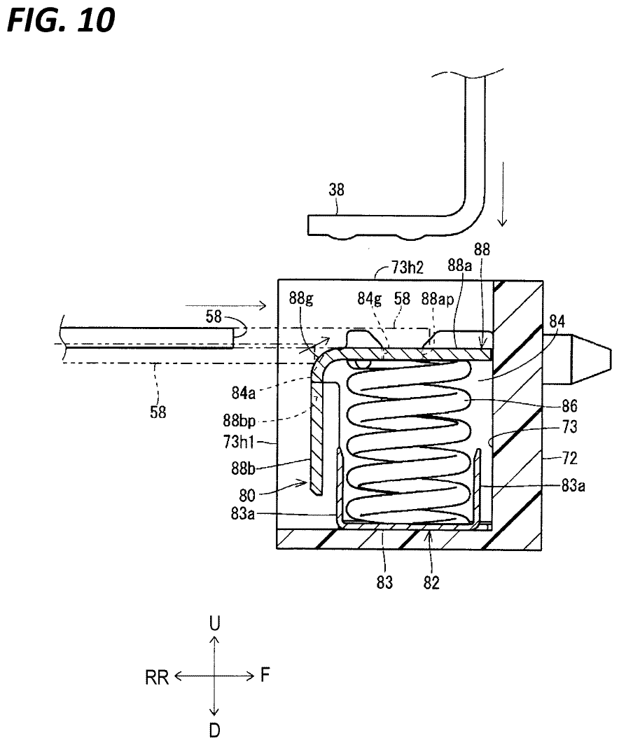

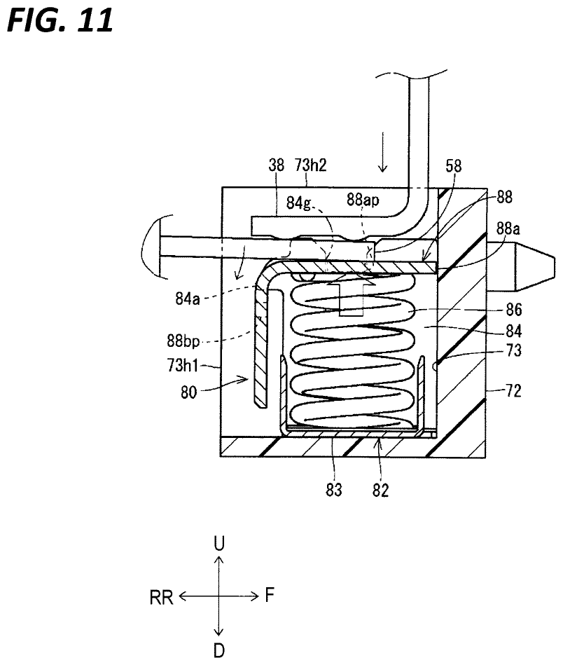

As described later, the coil end module 50 is attached to an end part of the armature 46 in the case body 42. Further, the terminal block module 70 is mounted into the lid portion 43. If the lid portion 43 is attached to the case body 42, the coil end lead terminals 58 are guided onto the processing pieces 88 through the inner openings 73h1 as shown in FIGS. 10 and 11. At this time, if the coil end lead terminals 58 are located below the pressing plate portions 88a, tip parts of the coil end lead terminals 58 contact the guide portions 88g. Since the coil end lead terminals 58 are supported in a cantilever manner, the coil end lead terminals 58 can be inclined to displace the tip parts of the coil end lead terminals 58 upward. In this way, the tip parts of the coil end lead terminals 58 can move onto the pressing plate portions 88a by being guided by the guide portions 88g.

In this way, the coil end lead terminals 58 are located on a side opposite to the bottom portions 83 with respect to the biasing members 86.

If the control device 30 is attached to the rotating electric machine 40, the outer busbar terminals 38 move onto the connecting members 80 through the outer openings 73h2. The outer busbar terminals 38 are arranged on a side opposite to the biasing members 86 with respect to the coil end lead terminals 58.

With the control device 30 attached to the rotating electric machine 40, the lower end position of the outer busbar terminal 38 is set at a position capable of compressing the biasing member 86 in consideration of a thickness of the coil end lead terminal 58 and a thickness of the pressing plate portion 88a. For example, with the control device 30 attached to the rotating electric machine 40, a gap smaller than the thickness of the coil end lead terminal 58 is set to be formed between the lower end position of the outer busbar terminal 38 and the pressing plate portion 88a.

With the control device 30 attached to the rotating electric machine 40, the lower end of the outer busbar terminal 38 presses the biasing member 86 downward via the coil end lead terminal 58 and the pressing plate portion 88a and compresses the biasing member 86. At this time, since the coil end lead terminal 58 is supported in a cantilever manner, the coil end lead terminal 58 can be inclined with the base end as a center if being pressed by the outer busbar terminal 38.

In this state, the pressing plate portion 88a is moved upward by a biasing force of the biasing member 86 to return to an original length. By this biasing force, the coil end lead terminal 58 is pressed against the outer busbar terminal 38. That is, in a completed state of the mechanically and electrically integrated unit 20, the biasing member 86 constantly biases the coil end lead terminal 58 to the outer busbar terminal 38. Thus, the coil end lead terminal 58 and the outer busbar terminal 38 are more reliably held in an electrically connected state.

In this embodiment, the pressing plate portion 88a of the processing piece 88 is interposed between the biasing member 86 and the coil end lead terminal 58 as described above. The processing piece 88 may be omitted and the biasing member 86 may directly press the coil end lead terminal 58 toward the outer busbar terminal 38.

As described above, a wiring unit 28 for rotating electric machine for connecting the coil wires 46a to the outer busbar terminals 38 inserted from the outside of the device case 41 is configured by the terminal block module 70 and the coil end module 50.

### Configurations Concerning Sensor Wirings

The terminal block module 70 is configured to pull out the speed sensor 100 in the device case 41 to outside.

That is, the terminal block module 70 is provided with the internal connector 74 for speed sensor and speed sensor wirings 60.

An extending portion 72E is integrally molded on one end part of the terminal block body 72. The extending portion 72E is formed with the internal connector 74 for speed sensor.

The internal connector 74 for speed sensor includes inner terminals 75 for speed sensor and is supported to be located in the device case 41 by the terminal block body 72. The internal connector 74 for speed sensor is a part configured to be connectable to a speed sensor side connector 106 of the speed sensor 100.

More specifically, the internal connector 74 for speed sensor includes an internal connector housing 74a and the inner terminals 75 for speed sensor. The internal connector housing 74a includes a recess, into which the speed sensor side connector 106 is insertable. The inner terminals 75 for speed sensor project from the bottom of the recess of the internal connector housing 74a. By inserting and connecting the speed sensor side connector 106 into the internal connector housing 74a, the inner terminals 75 for speed sensor are connected to terminals on the side of the speed sensor side connector 106.

The terminal block body 72 supports the internal connector 74 for speed sensor at a position facing the speed sensor side connector 106 of the speed sensor 100 to be incorporated into the device case 41. In this embodiment, a connection direction of the speed sensor side connector 106 to the internal connector 74 for speed sensor is set along the direction of the rotation axis X.

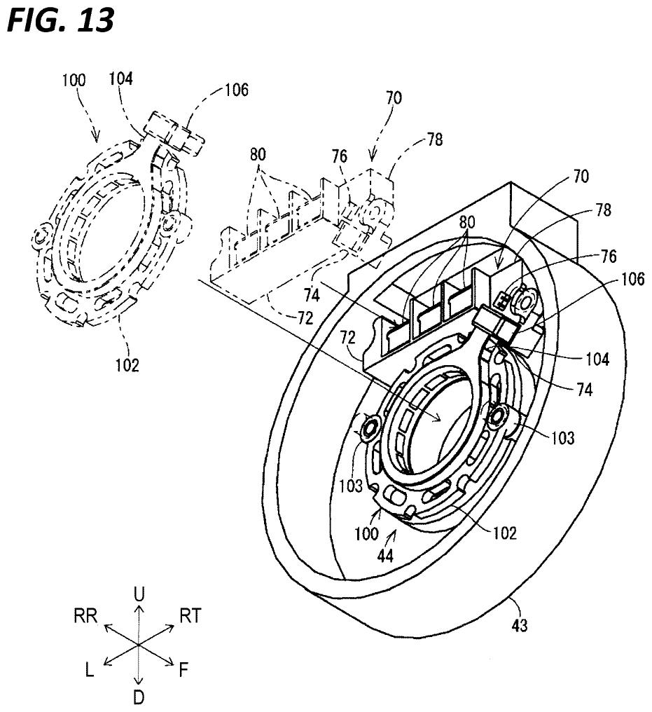

Here, the speed sensor 100 includes an annular body portion 102, a connector supporting portion 104 protruding outward from a circumferential part of the annular body portion 102 and the speed sensor side connector 106 supported on a tip part of the connector supporting portion 104 (see FIG. 13). A part wound with a coil wire is, for example, annularly arranged on the annular body portion 102. According to the rotation of the field magnet 49, a current excited by the coil wire is output via the speed sensor side connector 106. Note that it is not essential that the speed sensor 100 is configured as described above, and the speed sensor 100 may be a speed sensor utilizing an optical sensor, a magnetic sensor or the like.

The annular body portion 102 includes screwing portions 103 serving as attaching portions, and is mounted into the lid portion 43, utilizing the screwing portions 103. The speed sensor side connector 106 is located outside the annular body portion 102. Here, the internal connector 74 for speed sensor has a shape long in a tangential direction to a circle centered on the rotation axis X on a plane orthogonal to the rotation axis X.

The terminal block module 70 and the speed sensor 100 are also mounted into the lid portion 43. The position of the internal connector 74 for speed sensor in the terminal block module 70 is a position facing the speed sensor side connector 106 in a state mounted in the lid portion 43. Further, the internal connector 74 for speed sensor is facing rearward along the rotation axis X, and the speed sensor side connector 106 is facing forward along the rotation axis X. Thus, with the terminal block module 70 and the speed sensor 100 mounted in the lid portion 43, the internal connector 74 for speed sensor and the speed sensor side connector 106 are facing each other along the rotation axis X and connected to each other.

The speed sensor wirings 60 are at least partially held in the terminal block body 72, and connect the inner terminals 75 for speed sensor to terminals of an outer connector, which is a circuit from the outside of the device case 41. Note that a plurality of the speed sensor wirings 60 are provided to respectively correspond to a plurality of the inner terminals 75 for speed sensor (only some are shown in FIG. 6).

The speed sensor wiring 60 may be a part linearly punched from a metal plate made of copper or the like, may be a metal wire or may be a wire obtained by coating a metal strand with resin. In this embodiment, the speed sensor wiring 60 is assumed to be the part linearly punched from the metal plate made of copper or the like.

Further, the terminal block body 72 is assumed as a resin component molded with at least parts of the speed sensor wirings 60 as insert parts. The terminal block body 72 is a component including passage holes, through which the speed sensor wirings can be passed. With the speed sensor wirings arranged in the passage holes, gaps between the wirings and the passage holes may be filled with a filler or the like.

Further, the terminal block module 70 includes an external connector 78 including outer terminals 79t1 for speed sensor. The outer terminals 79t1 for speed sensor are connected to the speed sensor wirings 60. A plurality of the outer terminals 79t1 for speed sensor are provided to correspond to the number of the plurality of inner terminals 75 for speed sensor. The external connector 78 is a part supported by the terminal block body 72 to be connectable to an outer connector 39 from the outside of the device case 41.

More specifically, the external connector 78 includes an external connector housing 78a and the outer terminals 79t1 for speed sensor. The external connector housing 78a is a part integrally molded to the extending portion 72E of the terminal block body 72 and includes a recess, into which the outer connector 39 is insertable. The outer terminals 79t1 for speed sensor project from the bottom of the recess of the external connector housing 78a. By inserting and connecting the outer connector 39 into the external connector housing 78a, the outer terminals 79t1 for speed sensor are connected to terminals on the side of the outer connector 39.

The terminal block body 72 supports the external connector 78 at a position facing the outer connector 39 on the side of the control device 30 to be attached to the device case 41. In this embodiment, the control device 30 supports the outer connector 39 at a position adjacent to the outer busbar terminals 38. The outer connector 39 is supported to face toward the rotating electric machine 40, i.e. downward, and a connection direction of the outer connector 39 to the external connector 78 is set to a direction orthogonal to the rotation axis X, here the vertical direction. That is, the connection direction of the outer connector 39 to the external connector 78 is set along the direction from the outer peripheral side toward the inner peripheral side of the device case 41.

In an assembled state of the rotating electric machine 40, the control device 30 is attached to the rotating electric machine 40. At this time, the outer connector 39 is inserted into the external connector 78 from above through the opening 43h of the lid portion 43. With the control device 30 attached to the rotating electric machine 40, the outer connector 39 and the external connector 78 are facing each other and connected to each other.

As described above, the speed sensor side connector 106 of the speed sensor 100 is connected to the internal connector 74 for speed sensor, and the outer connector 39 is connected to the external connector 78. The inner terminals 75 for speed sensor of the internal connector 74 for speed sensor and the outer terminals 79t1 for speed sensor of the external connector 78 are connected via the speed sensor wirings 60. The internal connector 74 for speed sensor, the external connector 78 and the speed sensor wirings 60 are integrally incorporated into the terminal block module 70. Thus, the speed sensor 100 is connected to the control device 30 via the terminal block module 70.

The inner terminals 75 for speed sensor, the outer terminals 79t1 for speed sensor and the speed sensor wirings 60 may be integrally formed as a metal wiring member. For example, a metal wiring member in which the inner terminals 75 for speed sensor, the speed sensor wirings 60 and the outer terminals 79t1 for speed sensor are connected in this order may be formed by press-working a metal plate of copper or the like.

As described above, the terminal block body 72, the internal connector housing 74a, the external connector housing 78a may be components integrally molded of resin. In this case, the inner terminals 75 for speed sensor may be located in the internal connector housing 74a, the outer terminals 79t1 for speed sensor may be located in the external connector housing 78a and the speed sensor wirings 60 may be embedded as insert parts in the terminal block body 72 (here, the extending portion 72E). In this way, the terminal block module 70 can be easily integrally molded with the internal connector 74 for speed sensor and the external connector 78. Note that the terminal block body 72 may be formed by performing molding a plurality of times like two-color molding or double molding.

Further, the terminal block module 70 is configured to pull out the temperature sensor 110 in the device case 41 to outside.

That is, the terminal block module 70 is provided with the internal connector 76 for temperature sensor and temperature sensor wirings 62.

The internal connector 76 for temperature sensor is formed in the extending portion 72E in the one end part of the terminal block body 72.

The internal connector 76 for temperature sensor includes inner terminals 77 for temperature sensor and is supported by the terminal block body 72 to be located in the device case 41. The internal connector 76 for temperature sensor is a part configured to be connectable to the temperature sensor side connector 112 of the temperature sensor 110.

More specifically, the internal connector 76 for temperature sensor includes an internal connector housing 76a and the inner terminals 77 for temperature sensor. The internal connector housing 76a includes a recess, into which the temperature sensor side connector 112 is insertable. The inner terminals 77 for temperature sensor project from the bottom of the recess of the internal connector housing 76a. By inserting and connecting the temperature sensor side connector 112 into the internal connector housing 76a, the inner terminals 77 for temperature sensor are connected to terminals on the side of the temperature sensor side connector 112.

The terminal block body 72 supports the internal connector 76 for temperature sensor at a position facing the temperature sensor side connector 112 of the temperature sensor 110 to be incorporated into the device case 41. In this embodiment, a connection direction of the temperature sensor side connector 112 to the internal connector 76 for temperature sensor is set along the direction of the rotation axis X.

As described above, the temperature sensor 110 is held by the coil end module 50, and the temperature sensor side connector 112 is also held by the coil end module 50. The temperature sensor side connector 112 is facing forward along the rotation axis X. The temperature sensor side connector 112 is supported at a position on an outer peripheral side of the speed sensor side connector 106. The internal connector 76 for temperature sensor is facing rearward along the rotation axis X and, accordingly, facing the temperature sensor side connector 112.

If the lid portion 43 is attached to the case body 42 with the coil end module 50 mounted in the armature 46 in the case body 42 and the terminal block module 70 mounted in the lid portion 43, the temperature sensor side connector 112 and the internal connector 76 for temperature sensor move in directions toward each other and the both connectors 76, 112 are connected. At this time, since the temperature sensor side connector 112 is movably supported by the connector holding portion 54, the temperature sensor side connector 112 can be displaced in the vertical or lateral direction in accordance with the position of the internal connector 76 for temperature sensor even if there are position errors between the both connectors 76, 112.

The temperature sensor wirings 62 are at least partially held in the terminal block body 72, and connect the inner terminals 77 for temperature sensor to wirings on the side of the outer connector, which is a circuit from the outside of the device case 41. Note that a plurality of the temperature sensor wirings 62 are provided to respectively correspond to a plurality of the inner terminals 77 for temperature sensor.

The temperature sensor wiring 62 may be a part linearly punched from a metal plate made of copper or the like, may be a metal wire or may be a wire obtained by coating a metal strand with resin. In this embodiment, the temperature sensor wiring 62 is assumed to be the part linearly punched from the metal plate made of copper or the like.

Further, the terminal block body 72 is assumed as a resin component molded with at least parts of the temperature sensor wirings 62 as insert parts. The terminal block body 72 is a component including passage holes, through which the temperature sensor wirings can be passed. With the temperature sensor wirings arranged in the passage holes, gaps between the wirings and the passage holes may be filled with a filler or the like.

Further, the terminal block module 70 includes the external connector 78 including outer terminals 79t2 for temperature sensor. The outer terminals 79t2 for temperature sensor are connected to the temperature sensor wirings 62. A plurality of the outer terminals 79t2 for temperature sensor are provided to correspond to the number of the plurality of inner terminals 77 for temperature sensor. The external connector 78 is a part supported by the terminal block body 72 to be connectable to the outer connector 39 from the outside of the device case 41.

More specifically, the external connector 78 includes the external connector housing 78a and the outer terminals 79t2 for temperature sensor. The external connector housing 78a is a connector housing including the outer terminals 79t1 for speed sensor as described above. The outer terminals 79t2 for temperature sensor project from the bottom of the recess of the external connector housing 78a. That is, in this embodiment, the external connector 78 is a connector including the outer terminals 79t1 for speed sensor and the outer terminals 79t2 for temperature sensor and configured to output both a speed detection signal and a temperature detection signal.

By inserting and connecting the outer connector 39 into the external connector housing 78a, the outer terminals 79t2 for temperature sensor are connected to the terminals on the side of the outer connector 39.

As described above, the temperature sensor side connector 112 of the temperature sensor 110 is connected to the internal connector 76 for temperature sensor, and the outer connector 39 is connected to the external connector 78. The inner terminals 77 for temperature sensor of the internal connector 76 for temperature sensor and the outer terminals 79t2 for temperature sensor of the external connector 78 are connected via the temperature sensor wirings 62. The internal connector 76 for temperature sensor, the external connector 78 and the temperature sensor wirings 62 are integrally incorporated into the terminal block module 70. Thus, the temperature sensor 110 is connected to the control device 30 via the terminal block module 70.

The inner terminals 77 for temperature sensor, the outer terminals 79t2 for temperature sensor and the temperature sensor wirings 62 may be integrally formed as a metal wiring member. For example, a metal wiring member in which the inner terminals 77 for temperature sensor, the temperature sensor wirings 62 and the outer terminals 79t2 for temperature sensor are connected in this order may be formed by press-working a metal plate of copper or the like.

As described above, the terminal block body 72, the internal connector housing 76a, the external connector housing 78a may be components integrally molded of resin. In this case, the inner terminals 77 for temperature sensor may be located in the internal connector housing 76a, the outer terminals 79t2 for temperature sensor may be located in the external connector housing 78a and the temperature sensor wirings 62 may be embedded as insert parts in the terminal block body 72 (here, the extending portion 72E). In this way, the terminal block module 70 can be easily integrally formed with the internal connector 76 for temperature sensor and the external connector 78. Note that the terminal block body 72 may be formed by performing molding a plurality of times like two-color molding (double molding).

Note that the external connector 78 is an example of an external connector for speed sensor in that the outer terminals 79t1 for speed sensor are included. Further, the external connector 78 is an example of a connector for temperature sensor in that the outer terminals 79t2 for temperature sensor are included.

In the above embodiment, the external connector 78 is used as a connector for outputting both the temperature detection signal and the speed detection signal, but the external connector may be divided into a connector including outer terminals for speed sensor and a connector including outer terminals for temperature sensor.

### Terminal Assembly of Control Device

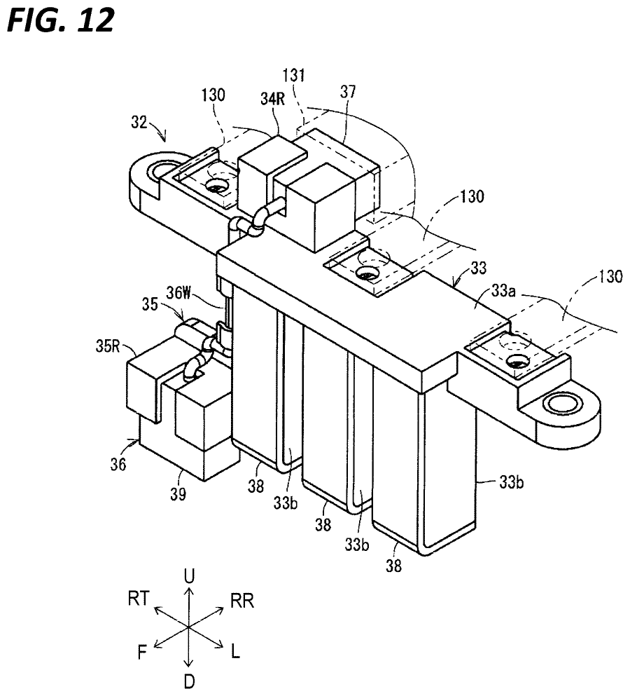

A terminal assembly 32 extending from the control device 30 toward the rotating electric machine 40 is described. FIG. 12 is a perspective view showing the terminal assembly 32. The control device 30 is a device for controlling the rotating electric machine 40 and includes an inverter control board. The control device 30 includes the terminal assembly 32 for connecting the inverter control board and the rotating electric machine 40.

The terminal assembly 32 includes a base member 33, the plurality of (here, three) outer busbar terminals 38 and a signal relaying portion 36.

The base member 33 includes a base plate portion 33a and column portions 33b projecting from the base plate portion 33a toward the rotating electric machine 40. The base plate portion 33a is fixed to a case of the control device 30 by screwing or the like.

The outer busbar terminal 38 is formed from a metal plate such as a copper plate. The outer busbar terminal 38 includes an elongated plate-like intermediate part and upper and lower end parts extending from both end parts of the elongated plate-like intermediate part while being bent toward one principal surface of the plate-like intermediate part. The upper end part of the outer busbar terminal 38 is arranged on the base plate portion 33a and connected to a busbar 130 extending from the inverter control board by screwing or the like. The plate-like intermediate part of the outer busbar terminal 38 extends along the front side surface of the column portion 33b. The lower end part of the outer busbar terminal 38 is arranged to overlap the lower surface of the base plate portion 33a.

The signal relaying portion 36 includes the outer connector 39, a board side connector 37 and a wiring 36W for connecting the both connectors. The wiring 36W is, for example, a wire. The outer connector 39 is supported by a connector supporting portion 35 located on one side part of the base member 33. The connector supporting portion 35 is located outside in an arrangement direction of a plurality of the column portions 33b. A lower end part of the connector supporting portion 35 is facing the external connector 78 in the terminal block module 70. The lower end part of the connector supporting portion 35 is formed with a box-shaped connector receiving portion 35R open downward. The inner wall surface of the connector receiving portion 35R is larger than the outer side surface of the outer connector 39. Thus, the connector receiving portion 35R supports the outer connector 39 in a state where the outer connector 39 can be allowed to move in the front-rear direction and the lateral direction. The wiring 36W is passed upward through the connector receiving portion 35R from the outer connector 39 and extends onto the base plate portion 33a.

A connector receiving portion 34R configured similarly to the connector receiving portion 35R is provided on the base plate portion 33a. The board side connector 37 is supported in a state allowed to move upward and in the lateral direction by the connector receiving portion 34R. A connector 131 on the side of the inverter control board is connected to the board side connector 37.

### Manufacturing Example of Mechanically and Electrically Integrated Unit

A manufacturing example of the mechanically and electrically integrated unit 20 is described.

First, the coil end module 50 is mounted on the end parts of the coil wires 46a of the armature 46 (see FIG. 4). In this way, the coil wires 46a are connected to each other in the predetermined combination. Further, some of the coil wires 46a are connected to the coil end lead terminals 58. The armature 46 may be incorporated into the case body 42 after or before the mounting of the coil end module 50.

Further, as shown in FIG. 13, the terminal block module 70 is attached to the lid portion 43 by screwing or the like. In this state, the internal connector 74 for speed sensor and the internal connector 76 for temperature sensor of the terminal block module 70 are facing rearward along the rotation axis X. Further, the inner openings 73h1 of the terminal block body 72 are facing rearward along the rotation axis X, and the outer openings 73h2 are facing toward the opening 43h, i.e. outward. Furthermore, the external connector 78 is facing toward the opening 43h, i.e. outward.

Subsequently, the speed sensor side connector 106 is fixed to the lid portion 43 by screwing or the like while being connected to the internal connector 74 for speed sensor. With the terminal block module 70 and the speed sensor side connector 106 mounted in the lid portion 43, the speed sensor side connector 106 and the internal connector 74 for speed sensor are facing each other along the rotation axis X. Thus, if the speed sensor 100 is moved toward the lid portion 43 along the rotation axis X, the both connectors 74, 106 are easily connected.

An assembly obtained by connecting the speed sensor side connector 106 and the internal connector 74 for speed sensor and assembling the terminal block module 70 and the speed sensor 100 may be attached to the lid portion 43 by screwing or the like.

It does not matter which of the attachment of the coil end module 50 to the armature 46 and the attachment of the terminal block module 70 or the speed sensor 100 to the lid portion 43 is performed earlier.

As described above, an integrated assembly of the terminal block module 70 and the speed sensor 100 with the speed sensor side connector 106 and the internal connector 74 for speed sensor connected is referred to as a speed sensor-integrated terminal block module 44 (see FIG. 13).

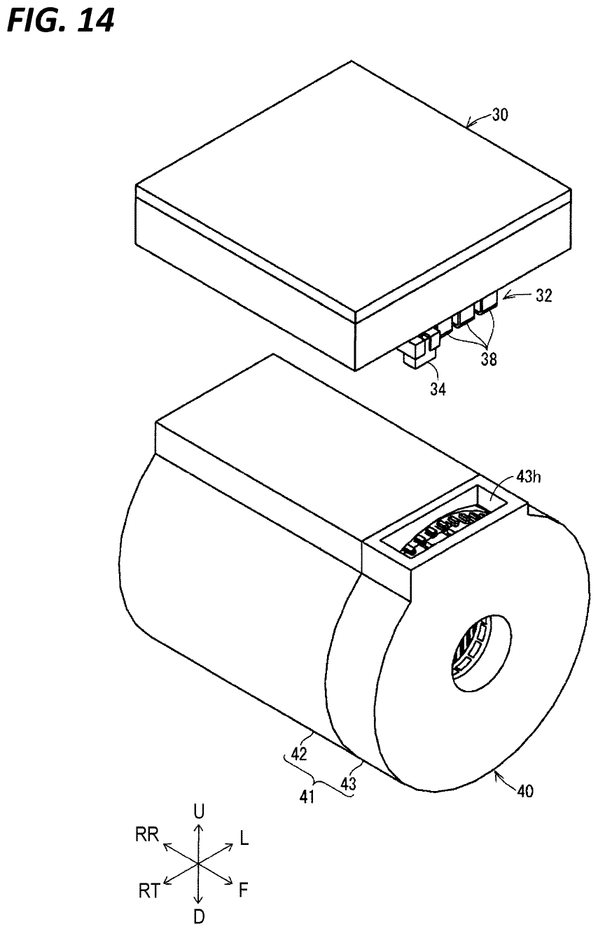

Then, as shown in FIG. 14, the lid portion 43 is fixed to the case body 42 by screwing or the like to close the front opening of the case body 42. At this time, the tip parts of the coil end lead terminals 58 are passed through the inner openings 73h1 along the rotation axis X and arranged on the connecting members 80. The tip parts of the coil end lead terminals 58 are arranged above the pressing pieces 88.

Further, the temperature sensor side connector 112 is also connected to the internal connector 76 for temperature sensor along the rotation axis X. At this time, the temperature sensor side connector 112 can move in the inner connector receiving portion 55. Thus, even if there are position deviations between the connectors 76 and 112, the temperature sensor side connector 112 can be displaced in accordance with the position of the temperature sensor side connector 76. Thus, the connectors 76, 112 are more reliably connected.

Thereafter, the control device 30 is attached to the rotating electric machine 40 by screwing or the like. At this time, the terminal assembly 32 is inserted into the rotating electric machine 40 through the opening 43h. The outer busbar terminals 38 are pressed against the upper surfaces of the coil end lead terminals 58 located on the connecting members 80 through the outer openings 73h2. The outer busbar terminals 38 press the biasing members 86 via the tip parts of the coil end lead terminals 58. In this way, the coil end lead terminals 58 are inclined with the base ends as fulcrums to displace the tip parts downward. Since the biasing members 86 are compressed, a state where the tip parts of the coil end lead terminals 58 are pressed against the tip parts of the outer busbar terminals 38 by biasing forces of the biasing members 86 is held.

Further, the outer connector 39 moves toward the external connector 78 through the opening 43h and is connected to the external connector 78. As described above, the outer connector 39 is supported movably in a direction orthogonal to the connection direction by the connector receiving portion 35R. Thus, even if there are position deviations between the connectors 39 and 78, the outer connector 39 can be displaced in accordance with the position of the external connector 78. Thus, the connectors 39, 78 are more reliably connected.

### Effects, Etc.

According to the terminal block module 70 configured as described above, if the terminal block body 72 holding the connecting members 80 is mounted and fixed into the device case 41, the internal connector 74 for speed sensor is arranged in the device case 41. If the speed sensor 100 is connected to the internal connector 74 for speed sensor, the speed sensor 100 is connected to the wirings outside the rotating electric machine 40 via the speed sensor wirings 60. Thus, the wirings 60 connected to the speed sensor 100 to be incorporated into the rotating electric machine 40 can be easily connected to the wirings outside the rotating electric machine 40, and the wirings are easily drawn.

Further, since the terminal block body 72 is a resin component molded with at least parts of the speed sensor wirings 60 as insert parts, the passage of a liquid along the speed sensor wirings 60 can be suppressed and liquid sealability can be improved.

Further, since the terminal block body 72 supports the internal connector 74 for speed sensor at the position facing the speed sensor side connector 106, the internal connector 74 for speed sensor can be easily connected to the speed sensor side connector 106 in incorporating the speed sensor 100 into the device case 41.

Further, since the connection direction of the speed sensor side connector 106 to the internal connector 74 for speed sensor is the direction along the rotation axis X, the connecting operation of the both connectors 74, 106 can be easily performed when the speed sensor 100 is mounted into the lid portion 43 by being moved along the rotation axis X.

Further, since the terminal block module 70 includes the external connector 78 for speed sensor, the control device 30 outside the rotating electric machine 40 can be easily connected to the speed sensor wirings 60 by connecting the outer connector 39 outside the device case 41 to this external connector.

In this case, if the inner terminals 75 for speed sensor, the outer terminals 79t1 for speed sensor and the speed sensor wirings 60 are integrally formed as the metal wiring member and the speed sensor wirings 60 are arranged as insert parts in the terminal block body 72, the terminal block module 70 including the respective connectors 39, 74 can be easily manufactured. Further, since the intermediate parts of the speed sensor wirings 60 are arranged in the terminal block body 72, a water-stopping property is also excellent.

Further, since the connection direction of the outer connector 39 to the external connector 78 is set to the direction from the outer peripheral side toward the inner peripheral side of the device case 41, a connection direction of the outer busbar terminals 38 to the connecting members 80 and the connection direction of the outer connector 39 are easily aligned and the connecting operation of those can be easily performed.

Further, the terminal block body 72 includes the inner openings 73h1 and the outer openings 73h2, the connecting members 80 press the coil end lead terminals 58 serving as the inner busbar terminals received through the inner openings 73h1 against the outer busbar terminals 38 received through the outer openings 73h2. Thus, even if a screw fixing operation is not performed to connect the respective terminals 58, 38, the respective terminals 58, 38 are easily connected.

Further, by connecting the internal connector for speed sensor of the terminal block module 70 and the speed sensor side connector 106 of the speed sensor 100, the terminal block module 70 and the speed sensor 100 are easily integrated in a state easily incorporated into the device case 41.

### Modification

It is not essential that the connecting component is configured as described above. For example, the connecting component may include a busbar for relaying and connecting the coil end lead terminal 58 and the outer busbar terminal 38. In this case, for example, one end part of this busbar may be fixed to the coil end lead terminal 58 by screwing, and the other end part may be connected to the outer busbar terminal 38 by screwing.

Note that the respective configurations described in the above embodiment and each modification can be appropriately combined without contradicting each other.

### LIST OF REFERENCE NUMERALS

20 mechanically and electrically integrated unit
28 wiring unit for rotating electric machine
30 control device
32 terminal assembly
33 base member
33a base plate portion
33b column portion
34R, 35R connector receiving portion
35 connector supporting portion
36 signal relaying portion
36W wiring
37 board side connector
38 outer busbar terminal
39 outer conductor
40 rotating electric machine
41 device case
42 case body
43 lid portion
43h opening
44 speed sensor-integrated terminal block module
46 armature
46a coil wire
49 field magnet
50 coil end module
52 coil end holding portion
52h insertion hole
53 relay busbar
53a connection end
54 connector holding portion
54P wire supporting portion
55 inner connector receiving portion
55g wire insertion groove
58 coil end lead terminal (inner busbar terminal)
60 speed sensor wiring (insert part)
62 temperature sensor wiring (insert part)
62, 75, 79t1 metal wiring member
70 terminal block module
71 screwing portion
72 terminal block body
72E extending portion
73 accommodation recess
73h1 inner opening
73h2 outer opening
74 internal connector for speed sensor
74a internal connector housing
75 inner terminal for speed sensor
76 internal connector for temperature sensor
76a internal connector housing
77 inner terminal for temperature sensor
78 external connector
78a external connector housing
79t1 outer terminal for speed sensor
79t2 outer terminal for temperature sensor
80 connecting member
82 supporting member
83 bottom portion
83a positioning piece
84 side plate
84a retaining piece
84g guide groove
86 biasing member
88 pressing piece
88a pressing plate portion
88ap, 88bp protrusion
88b hanging plate portion
88g guide portion
100 speed sensor
102 annular body portion
103 screwing portion
104 connector supporting portion
106 speed sensor side connector (connector of speed sensor)
110 temperature sensor
112 temperature sensor side connector (connector of temperature sensor)
114 wire
130 busbar
131 connector
X rotation axis

1. A terminal block module to be fixed to a device case of a rotating electric machine provided with a speed sensor, comprising:
a connecting member for electrically connecting an inner busbar terminal in the device case and an outer busbar terminal outside the device case;
a terminal block body to be fixed to the device case while holding the connecting member;
an internal connector for speed sensor including an inner terminal for speed sensor, the internal connector for speed sensor being supported by the terminal block body to be located in the device case; and
a speed sensor wiring at least partially held in the terminal block body, the speed sensor wiring connecting the inner terminal for speed sensor to a circuit from outside of the device case.

2. The terminal block module of claim 1, wherein the terminal block body is a resin component molded with at least a part of the speed sensor wiring as an insert part.

3. The terminal block module of claim 1, wherein the terminal block body supports the internal connector for speed sensor at a position facing a connector of the speed sensor to be incorporated into the device case.

4. The terminal block module of claim 1, wherein a connection direction of a connector of the speed sensor to the internal connector for speed sensor is set along a rotation axis direction of the rotating electric machine.

5. The terminal block module of claim 1, further comprising an external connector including an outer terminal for speed sensor connected to the speed sensor wiring, the external connector being supported by the terminal block body to be connectable to a connector from the outside of the device case.

6. The terminal block module of claim 5, wherein:
the internal connector for speed sensor includes an internal connector housing,
the external connector includes an external connector housing,
the inner terminal for speed sensor, the outer terminal for speed sensor and the speed sensor wiring are integrally formed as a metal wiring member,
the terminal block body, the internal connector housing and the external connector housing are components integrally molded of resin, and
the inner terminal for speed sensor is located in the internal connector housing, the outer terminal for speed sensor is located in the external connector housing and the speed sensor wiring is arranged as an insert part in the terminal block body.

7. The terminal block module of claim 5, wherein a connection direction of an outer connector to the external connector is set along a direction from an outer peripheral side toward an inner peripheral side of the device case.

8. The terminal block module of claim 1, wherein:
the terminal block body includes an inner opening for receiving the inner busbar terminal along the rotation axis direction of the rotating electric machine and an outer opening for receiving the outer busbar terminal along a direction from an outer peripheral side toward an inner peripheral side of the device case, and
the connecting member presses the inner busbar terminal received through the inner opening against the outer busbar terminal received through the outer opening.

9. A speed sensor-integrated terminal block module, comprising:
the terminal block module of claim 3, and
the speed sensor connected to the internal connector for speed sensor.
